(19) United States
(12) Patent Application Publication
(10) Pub. No.: US 2007/0018469 A1
(43) Pub. Date: Jan. 25, 2007

(54) Contamination-free edge gripping mechanism with withdrawable pads and method for loading/unloading and transferring flat objects

(75) Inventors: Elik Gershenzon, Daly City, CA (US); Boris Kesil, San Jose, CA (US)

Correspondence Address: Boris Kesil;Multimetrixs LLC, 1040 Di Giulio #200, Santa Clara, CA, 95050, US

(73) Assignee: MultiMetrixs, LLC

(21) Appl. No.: 11/188,249

(22) Filed: Jul. 25, 2005

(51) Int. Cl. B65G 49/07

(52) U.S. Cl. 294/103.1

(57) ABSTRACT

A wafer gripping mechanism of the invention comprises a thin flat body having one linearly moveable and rotating finger for gripping an edge of the flat object and a pair of soft withdrawable object supporting pads. A distinguishing feature of the mechanism of the invention is that the wafer supporting pads are withdrawable for placing the pads into position where they do not project beyond the outlines of the external surface of the insertable portion of the gripper. The absence of elements projecting from the surface of the gripper portion insertable into narrow spaces with high speed protects the gripping mechanism, wafer, chuck, etc. from damage due to possible collision. All the drive and actuation mechanisms that are used for rotation and axial movement of the gripping finger, as well as for rotation of the withdrawable pads are enclosed in a thin hollow casing made from a thin and light-weight sheet metal.

### CROSS-REFERENCES TO RELATED APPLICATIONS

The present patent application is related to pending U.S. patent application Ser. No. 11/036,870 filed by E. Gershenzon, et al. on Jan. 18, 2005 and entitled “Contamination-Free Edge Gripping Mechanism and Method for Loading/Unloading and Transferring Flat Objects”.

### FIELD OF THE INVENTION

The present invention relates to the field of material handling equipment, in particular to mechanisms and methods used in semiconductor production, disk-drive manufacturing industry and the like for precision gripping, transferring, and positioning delicate, thin and highly accurate flat objects such as semiconductor wafers, hard disks, etc. More specifically, the present invention relates to an edge gripping mechanism for transferring semiconductor wafer substrates, e.g., between a FOUP (front opening unified pod) and another substrate storage and a wafer processing station, or the like. The mechanism of the invention may be especially useful for loading/unloading semiconductor wafers or wafer substrates into/from storage cassettes with narrow spaces between parallelly stacked wafers stored in the cassette and for transferring the wafers or substrates between the storage cassette and the wafer/substrate chuck of a processing station.

### BACKGROUND OF THE INVENTION

From the beginnings of the semiconductor industry to the late 1980s, wafers were handled manually and later by rubber-band conveyors and cassette elevators. The first standards for wafer of 2″, 4″, 6″ diameters and appropriate cassette dimensions allowed to develop simple wafer handling mechanisms and standardize their designs. The early forms of automated handling contributed to improved yields by reducing wafer breakage and particle contamination. A variety of equipment layouts were used, but the general conception remained the same. In other words, the automation systems of that time relied mostly on stepper-motor-driven conveyor belts and cassette elevators to eliminate manual handling.

A central track would shuttle wafers between elevator stations that serviced cassettes and “tee” stations that serviced the process stations. This to some extent helped to reduce breakage, but did not solve the contamination problem. Furthermore, most equipment had manual loading as the standard, with the conveyor and elevators added. These systems were reliable and cheap and served as a good prerogative to automation of wafer handling by the times when 200-mm wafers came into use.

Further progress of the industry accompanied by an increase in the diameter of wafer with 200-mm diameter as a standard for substrates led to drastic changes in principles wafer handling occurred. Driven by ever-decreasing linewidths, tighter cleanliness and throughput requirements, and improvements in robotic technology, the rubber-band conveyor/cassette elevator solution was surpassed by true robotic wafer handling.

The new robotics consisted of polar-coordinate robot arms moving wafers with so-called “end effectors”. In robotic, the end effector is a device or tool connected to the end of a robot arm. For handling semiconductor wafers, an end effector may be made in the form of grippers of the types described, e.g., in U.S. Pat. No. 5,108,140, No. 6,116,848, and No. 6,256,555. More detailed description of these end effectors or grippers will be considered later.

These robots were an improvement over the earlier technology. Since the robot's movements were controlled by microprocessor-based servo controllers and servomotors, it became possible to greatly improve the throughput, reliability, and error handling of the wafer handling systems. For example, a typical rubber-band conveyor and cassette elevator system could handle only tens of wafers per hour, while a three-axis robot could move hundreds. Reliability for robots was increased at least up to 80,000 hours mean time between failures (MTBF) compared to a few thousand hours for the conveyor systems.

Introduction of microprocessor control allowed true unattended equipment operation. Operators could manually load cassettes, and the tool could automatically process full wafer lots. Standards also were improved and introduced into use (see, e.g., SEMI standards). However, these standards helped reduce, but did not eliminate, the confusion involved in the selection and application of robotic wafer handling. For example, there are SEMI standards for cassettes, yet many nonstandard cassettes are used. Another compromise is the need to design semiconductor-manufacturing equipment suitable for accepting a large variety of wafer sizes. This adds unnecessary complexity to equipment design.

Furthermore, many equipment manufacturers built their own robots. Each model had to be adaptable to many different wafer sizes and a variety of cassettes.

Recent transfer to 300-mm wafers evolved new problems associated with much higher final cost of a single wafer (up to several thousand dollars as compared with several hundred dollars for 200 mm wafers) and thus required higher accuracy and reliability of the wafer handling equipment. These problems become even more aggravated for handling double-sided polished wafers, where both sides of the wafer are used for the production of the chip. A specific feature of end effectors intended for handling double-sided polished wafers is that they can touch the wafers only at their edges.

Furthermore, transition to 300 mm wafers made the use of low vacuum unsuitable for holding and handling the wafers. The main reason is that in order to protect the wafer from contamination through the mechanical contact with holding parts of the robot arm, both sides (front or back) of the wafer become untouchable for handling. Another reason is that vacuum holders are not reliable for handling wafers of heavy weight. Thus, the conventional vacuum end effectors appeared to be unsuitable for handling expensive, heavy, and hard-to-grip wafers of 300 mm diameter.

According to Semi Standards, the allowance for the gripping area of the 300 mm wafer should not exceed 3 mm from the edge of the wafer and preferably to be down to 1.5 mm or even less. To reliably hold the wafer and to protect it from breaking during all handling transportation procedures, it is necessary to use a limited holding force of at least at 3 points circumferentially spaced along the edge of the wafer.

There exist a great variety of end effectors with edge grippers for handling thin flat objects such as wafer substrates. Some typical end effectors of the edge-gripping type are described below.

For example, U.S. Pat. No. 6,167,322 issued on Dec. 26, 2000 to O. Holbrooks describes intelligent wafer handling system that removes wafers from the wafer cassette using a thin flat gripper that can slip in between parallelly stacked and spaced wafers and has two proximal stationary posts for contact with the edge on one side of the wafer and one or two short distal rotating fingers on the ends of the sliding rods for contact with the edge on the diametrically opposite side of the wafer. The aforementioned distal rotating fingers are made rotatable in order to turn them into non-gripping position coplanar with the plane of the flat gripper and, hence, parallel to the plane of the wafer for insertion between the wafers in the storage cassette. When during insertion into the cassette the distal finger reaches the extreme position behind the aforementioned diametrically opposite side of the wafer, the distal fingers are turned by 90° relative to the plane of the wafer and shifted in the direction of proximal posts for gripping the wafer at its edge. The wafer is now ready for extraction from the cassette by withdrawing the flat gripper for subsequent transfer of the wafer to the destination, e.g., to a chuck of a processing station.

In the Holbrooks's device the flat edge gripper is inserted into the cassette underneath the wafer. Therefore, in order to place the removed wafer, e.g., to the chuck of a processing station, this chuck should have a special construction with feature that would allow insertion of the wafer to the position suitable for clamping the wafer in the chuck.

For example, the chuck should have wafer-supporting pins, which are moveable in the direction perpendicular to the wafer plane. The wafer is placed by the gripper onto the pins, which are lowered into the wafer clamping position for wafer processing and are raised upon completion of the treatment for picking up the wafer by the edge gripper. Provision of moveable parts such as pins in the vicinity of the wafer may cause contamination of the wafer surface by the products of wear of the moveable parts. Alternatively, a chuck may have profiled recesses for insertion and subsequent removal of the gripper after the wafer has been loaded.

Many other known edge grippers are based on the same principles as the Holbrooks's device with positioning of the gripper underneath the wafer, wafer substrate, hard disk, or a similar flat object. The object is gripped at its edge portion and has contact with the gripping elements at least at three points. See, e.g., U.S. Pat. No. 6,116,848 issued in 2000 to D. Thomas, et al. U.S. Pat. No. 6,053,688 issued in 2000 to D. Cheng, U.S. Pat. No. 6,256,555 issued in 2001 to P. Bacchi, et al., U.S. Pat. No. 6,485,253 issued in 2002 to J. Adams, et al., etc. The aforementioned devices differ from each other only by the kinematics of the drive for moveable parts, profiles of the gripping elements, and the shape of the gripper itself.

A disadvantage of the wafer handling system of Holbrooks consists in that this apparatus does not provide control of gripping speed at different stages of the gripping cycle. Another disadvantage of the Holbrooks system consists in that this system does not provide decrease in gripping pressure when the gripper approaches the edge of the wafer with acceleration.

An attempt to solve the aforementioned problems of the prior art was made in U.S. patent application Ser. No. 09/944,605 filed in 2001 by B. Kesil, et al. The precision soft-touch gripping mechanism disclosed in that application has a mounting plate attached to a robot arm. The plate supports a stepper motor. The output shaft of the stepper motor is connected through a spring to an elongated finger that slides in a central longitudinal slot of the plate and supports a first wafer gripping post, while on the end opposite to the first wafer gripping post the mounting plate pivotally supports two L-shaped fingers with a second and third wafer gripping posts on their respective ends. The mounting plate in combination with the first sliding finger and two pivotal fingers forms the end effector of the robot arm, which is thin enough for insertion into a wafer-holding slot of a wafer cassette. The end effector is equipped with force sensors for controlling the wafer gripping force. Several embodiments relate to different arrangements of gripping rollers and mechanisms for control of the gripping force and speed of gripping required for gripping the wafer with a soft and reliable touch.

A specific feature of the mechanism of U.S. patent application Ser. No. 09/944,605 that advantageously distinguishes it from the Holbrooks system is that the proposed mechanism for the first time suggests the use of three moveable fingers with gripping posts at the ends of the fingers that are arranged circumferentially around the periphery of the wafer and that have an independent soft touch at each post.

Experiments showed that the mechanism of U.S. patent application Ser. No. 09/944,605 has the lowest level of contamination (which is extremely important for satisfying the clean-room requirements). This is achieved due to the fact that all sliding pairs are isolated from the zone where wafers are located and due to the fact that the distal post is stationary. However, a disadvantage of the stationary post, which has a predetermined height, is that, in order to prevent interference between the post and the wafer, the mechanism requires the use of complicated wafer position detecting sensors.

The last-mentioned drawback is solved in the aforementioned Holbrooks system that utilizes a rotatable distal pin, which is turned by 90° for orientation in the plane parallel to the surface of the wafer when the pin is inserted into the slot of the wafer storage cassette. In fact, due to the presence of the notch on the edge of the wafer, in order to prevent interference of the post with the notch, the mechanism should have at least two distal posts. This means that the members of the mechanism located in the zone of wafers have two rotary sliding pairs that are turned at least by 90° and may cause contamination of the wafer with the product of wear.

In order to solve the above problem, the applicants have developed a soft-touch gripping mechanism for flat objects disclosed in aforementioned U.S. patent application Ser. No. 10/719,411 filed by B. Kesil et al., on Nov. 24, 2003 and entitled “Soft-Touch Gripping Mechanism for Flat Objects”. In the mechanism of the last-mentioned patent application, the soft touch is achieved by transmitting the movement of the pusher to the linear fingers through a spring. In order to facilitate insertion of the rotating distal finger into narrow slots between the flat objects, such as semiconductor wafers in the storage cassette, the distal post can be turned by an angle less 90°. Reduced rotary sliding movement minimizes a chance of contamination of the wafer with products of wear.

Analysis of the latest edge grippers for handling delicate objects such as semiconductor wafers or wafer substrates, including those mentioned in aforementioned patent applications of the applicants, reveals the following trends: 1) increase in the speed of gripper movements; 2) decrease in the thickness of the flat gripper (i.e., of the height of the gripper's transverse cross section); 3) increase in the vibration-damping properties of the gripper; 4) maintaining soft touch in gripping under the conditions of increased speed of the gripper; 4) reduction of contamination by wear products. The trends 1) to 4) are interrelated with each other.

Regarding item 1), it should be note that the increase in speed of the gripper movement is dictated by the demand for increase in the productivity of the wafer processing stations and, hence, for reduction of the time required for loading/unloading and transporting of the objects such as wafer substrates, wafers, etc. However, an increase in the speeds of the edge grippers, with and without the objects, is associated with an increase in acceleration of moving parts. Therefore, in order to diminish the forces developed by an accelerated gripper, especially, when it carries an object, and in order to ensure secure hold of the object in the gripper, it is necessary to reduce the mass of the gripper. In other words, the gripper body should be made thinner. On the other hand, the thinner is the gripper's body, the more chances that the gripper will be subject to transverse oscillations, and therefore the gripper should have a vibration-damping structure, as mentioned in item 3). However, an increase in the damping properties should not contradict with a reduced thickness of the gripper body (requirement of Item 2) for insertion into narrow slots. Regarding Item 4), attempts have been made to prevent contamination. For example, U.S. Pat. No. 6,474,712 issued in 2002 to B. Govzman discloses an edge gripper with vertical orientation of the wafer in order to prevent contamination of the lower-level wafers with wear products in a cassette with horizontally arranged wafers. However, the vertically-orientated grippers require additional mechanisms of rotation for placing the wafers into a chuck or the like. This makes the construction of wafer processing equipment more complicated. On the hand, some technological processes and devices may not allow vertical orientation at all. U.S. Pat. No. 6,474,712 demonstrates an attempt to solve the problem associated with contamination that was also mentioned, e.g., in U.S. Pat. No. 5,000,652 issued in 1991 to R. Christensen, et al. In the “Prior-Art” section, the above patent refers to one of IBM edge grippers for handling semiconductor wafers, where the mechanism is disposed over the active surface of the wafer and therefore may cause contamination of the wafer surface. Thus, although a position of the gripper above the object such as a wafer substrate or a wafer is attractive from the point of view of simplicity of object transfer to the chuck and loading to the chuck, none of the overhead grippers known to the applicants found practical application for the reasons described above.

As has been mentioned above, the applicants have partially solved the contamination problem by developing a soft-touch gripping mechanism for flat objects disclosed in aforementioned U.S. patent application Ser. No. 09/944,605, where the level of contamination was reduced to no more than 5 particles per cubic feet in the wafer-handling environment. This result was confirmed by multiple measurements.

Finally, in edge grippers known to the applicants at least the backside of the object is normally brought in surface-to-surface contact with the gripper or with supporting pins, which is undesirable from the point of view of possible contamination.

In an attempt to solve the problems of the prior art associated with the use of edge-gripping mechanisms for loading/unloading semiconductor wafers, the applicants have developed a contamination-free edge gripping mechanism that was capable of increasing the speed of gripper movements, had a reduced thickness in a transverse cross section, was characterized by improved vibration-damping properties and maintained soft touch in gripping under the conditions of increased speed. This mechanism is disclosed in pending U.S. patent application Ser. No. 11/036,870 filed by Boris Kesil, et al. on Jan. 18, 2005. During operation, the gripping mechanism is positioned over the object. In spite of an overhead position, the gripping mechanism is contamination-free and even has much lower level of contamination than the conventional grippers positioned underneath the object. This is achieved by making the body of the gripper in the form of a thin closed casing and by enclosing all moveable parts in the casing. The inner surface of the casing is used as a mounting surface for supporting drive mechanisms for moveable fingers, force control means and other elements required for soft-touch control, etc. In the vicinity of the edge-gripping fingers, the mechanism is provided with soft edge-supporting pads having tapered surfaces for self-alignment and centering of the circular objects in the gripper. The purpose of the pads is to eliminate surface contact between the wafer and the flat gripper by supporting the wafer in the gripper at three or four points of contact with the pads, whereby a small gap is formed between the surface of the gripper body and the surface of the wafer. The overhead position of the gripper with respect to the object makes it possible to simplify the construction of a wafer-holding chuck, e.g., on wafer processing stations. This is because, in contrast to the conventional chucks that cooperate with the edge grippers located underneath the wafer, the chuck suitable for the gripper of the invention may be loaded from above the chuck by simply aligning the gripper with the object relative to the chuck and dropping the object for loading under gravity. Furthermore, in order to eliminate object ejecting pins used in conventional chucks for uplifting the object up to a position required for edge gripping, the gripper of the invention has auxiliary object-uplifting means in the form of vacuum suction ports or in the form of blowing nozzles that generate a vortex effect for uplifting the flat object from the support surface to the level required for edge gripping. The light-weight structure of the gripper makes it possible to increase the speed of movements without risk of generation of vibrations.

However, in the wafer storage cassettes of the latest models semiconductor wafers are arranged with a pitch of 6.3 mm. A semiconductor wafer itself has a thickness of 0.8 mm. Thus, the remaining 5.5 mm has to be used for inserting the insertable part of the narrow gripper, for raising the gripper finger and pads, and 1 mm tolerance on each side for oscillations of the insertable portion that moves and reverses with high speed in the aforementioned narrow space. A similar narrow space of 5.5 to 6 mm corresponds to the height of the spaces over a wafer chuck for lateral insertion and withdrawal of the flat gripping mechanism into and from the chuck used on some wafer processing operations. At such condition, projection of the wafer supporting pads over the surface of the insertable part of the gripping mechanism may lead to accidental collision of the pad with the adjacent wafer or with the surfaces of the chuck. Such a collision may seriously damage the gripping mechanism, chuck, cassette, or products, especially when the gripper in inserted with high speed.

### OBJECTS AND SUMMARY OF THE INVENTION

In view of the above, it is an object of the present invention to provide a contamination-free edge gripping mechanism that has object supporting pads withdrawable in flush with the surface of the flat gripper for unobstructed insertion of the gripper into narrow spaces. It is another object is to provide a method for high-speed loading/unloading and transferring flat objects from spaces as narrow as 5.5 mm or narrower.

A wafer gripping mechanism of the invention comprises a thin flat body having one linearly moveable and rotating finger for gripping an edge of the flat object and a pair of soft withdrawable object supporting pads. An object may be, e.g., a semiconductor wafer that has to be gripped for transfer to a processing station, or into or from a wafer storage cassette. The pads have tapered surfaces for self-alignment and centering of the wafer, or another round flat object. Provision of the aforementioned pads makes it possible to eliminate surface contact between the wafer and the surface of the gripper body, while contact of the wafer with the pads occurs on the wafer margin areas allowed for engagement. A distinguishing feature of the mechanism of the invention is that the wafer supporting pads are withdrawable, e.g., due to rotation by an angle of 90° or less for placing the pads into position where they do not project beyond the outlines of the external surface of the insertable portion of the gripper. The absence of elements projecting from the surface of the gripper portion insertable into narrow spaces with high speed protects the gripping mechanism, wafer, chuck, etc. from damage due to possible collision. All the drive and actuation mechanisms that are used for rotation and axial movement of the gripping finger, as well as for rotation of the withdrawable pads are enclosed in a thin hollow casing made from a thin and light-weight sheet metal. The finger and pads are driven from the same reversable motor through a system of small-diameter gears that can be placed into the interior of the hollow casing.

### BRIEF DESCRIPTION OF THE DRAWINGS

FIG. 1 is a general front-side three-dimensional external view of an edge gripper made in accordance with one embodiment of the invention.

FIG. 2 is a schematic view of the end gripper of FIG. 1 that shows the kinematics of the drive and actuation mechanisms in a wafer gripped position.

FIG. 3 is a view similar to FIG. 1 with the cover removed for illustrating relative positions of parts in one example of an actual construction.

FIG. 4 is a schematic view of a gripper similar to FIG. 2 but illustrating drives and kinematics of moving parts in the wafer release position or prior to insertion into a wafer cassette.

FIG. 5 is a fragmental three-dimensional view of a wafer gripping finger in a hidden position when the finger does not project beyond the outlines of the gripper body surface.

FIG. 5a is a fragmental view illustrating one of the pads in a hidden position prior to insertion into a narrow space.

FIG. 6 is similar to FIG. 5 but illustrating the wafer gripping finger turned into the position ready for gripping.

FIG. 6a is a fragmental view illustrating one of the pads in a raised position for supporting the marginal area of the wafer.

FIG. 7 is a fragmental three-dimensional view of one of the wafer supporting pads in a hidden position when the pad does not project beyond the outlines of the gripper body surface.

FIG. 8 is similar to FIG. 7 but illustrating a wafer supporting pad turned into the position ready for supporting the wafer.

FIG. 9a illustrates the insertable portion of the gripper inserted between the adjacent wafers of the wafer cassette.

FIG. 9b shows gaps between the insertable portion of the gripper and the surfaces of the adjacent wafers in the cassette.

FIG. 10 is the same view as shown in FIG. 4 for embodiment of the gripper where all wafer supporting pads are rotatable.

### DETAILED DESCRIPTION OF THE INVENTION

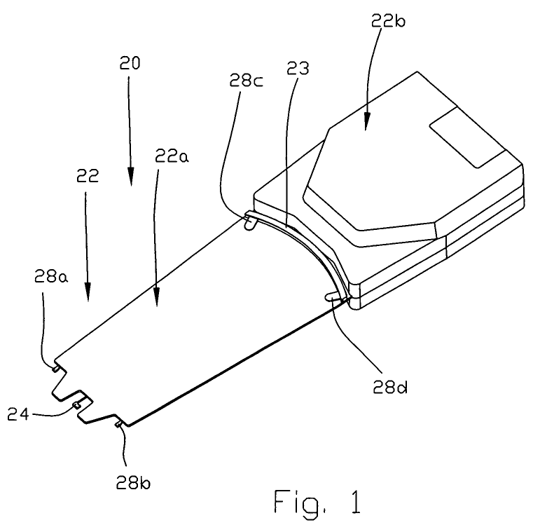

In general, the edge-gripping mechanism of the present invention is similar to the one disclosed in pending U.S. patent application Ser. No. 11/036,870 of the same applicants (files on Jan. 18, 2005) and is aimed at the improvement of the aforementioned gripper. A general front-side three-dimensional external view of an edge gripper 20 made in accordance with one embodiment of the invention is shown in FIG. 1. It can be seen that the gripper body 22 consists of a thin flat tapered portion 22a that is insertable into narrow spaces, e.g., between the wafers in the wafer storage cassette (not shown in FIG. 1), and a thicker housing portion 22b. The insertable portion 22a supports a rotatable gripping finger 24 arranged on the longitudinal axis X-X of the gripper 20 on the distal end of the latter and a pair of withdrawable wafer supporting pads 28a and 28b. The pads 28a and 28b are offset laterally from the axis X-X and arranged symmetrically with respect to the axis. Reference numeral 25 (FIG. 1) designates a stationary arch-shaped wafer gripping sector that grips the wafer edge when the moveable gripping finger 24 edges the wafer towards this sector, as will be explained later.

In spite of the fact that the insertable portion 22a of the gripper body 22 is thin, it is made hollow from a strong light-weight material such as amorphous aluminum for low temperature applications (not exceeding 300° C.) or titanium for high-temperature applications (exceeding 300° C.). The thickness of the insertable portion 22a of the gripper body 22 does no exceed 3 mm. The use of such a relative soft material imparts to the gripper body vibration-damping properties required for damping vibrations that otherwise could occur due to increased speed of movements of the gripping finger and pads. The insertable portion 22a of the gripper body 22 is tapered towards the distal end and has a wider portion on the proximal end that supports stationary wafer supporting pads 28c and 28d. The stationary pads 28c and 28d are also offset laterally from the axis X-X and arranged symmetrically with respect to the axis X-X. Two rotatable pads 28a and 28b are shown only as an example and, if necessary, all four wafer supporting pads can be made rotatable from the same drive.

The thick housing portion 22b of the gripper body 22 encloses various drive, control, and actuating mechanisms (described later) of the rotatable gripping finger 24a and withdrawable pads 28a, 28b. It is assumed that the housing portion has means for connecting to a wafer manipulating mechanism, such as a robot arm, which is beyond the scope of the present invention and is not shown in the drawing.

The above-described mechanism is contamination-proof since all drive and actuating mechanisms are completely enclosed in the hollow housing.

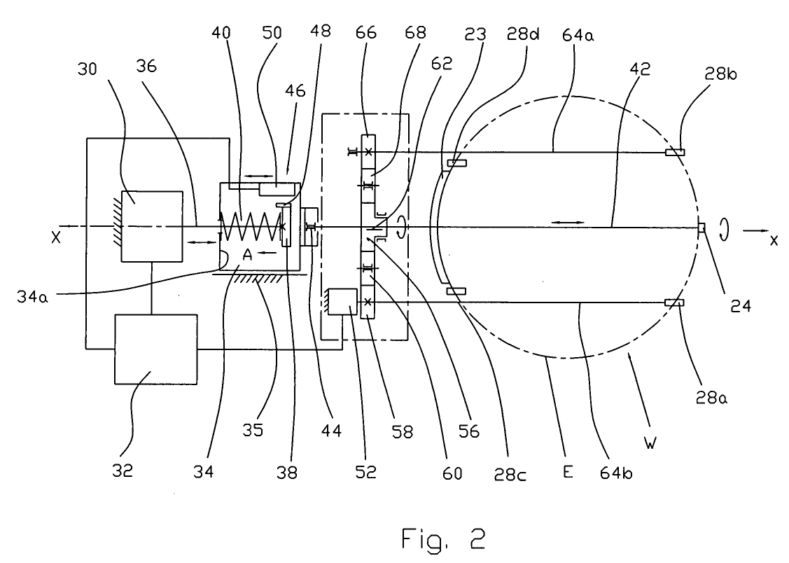

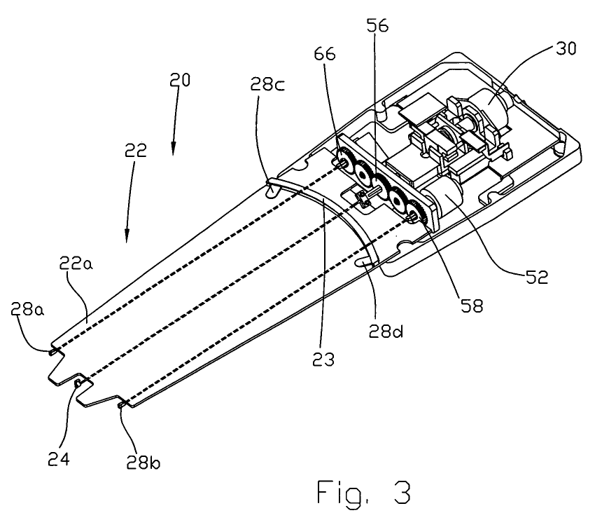

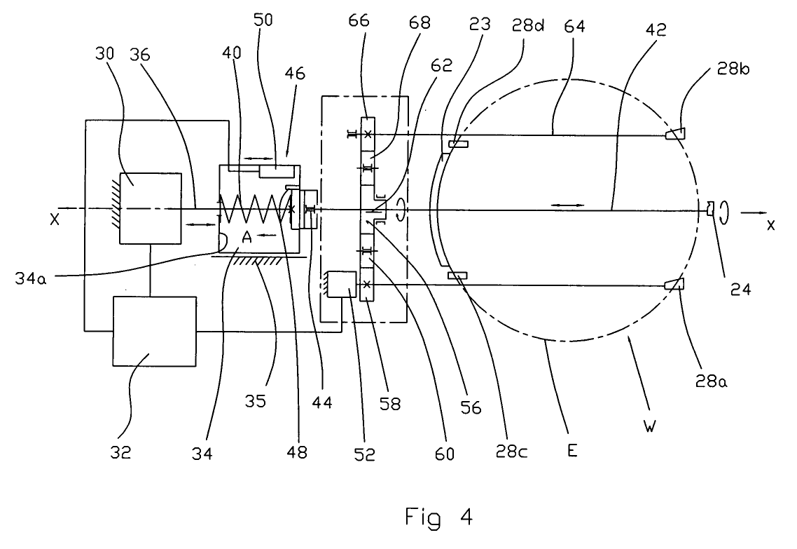

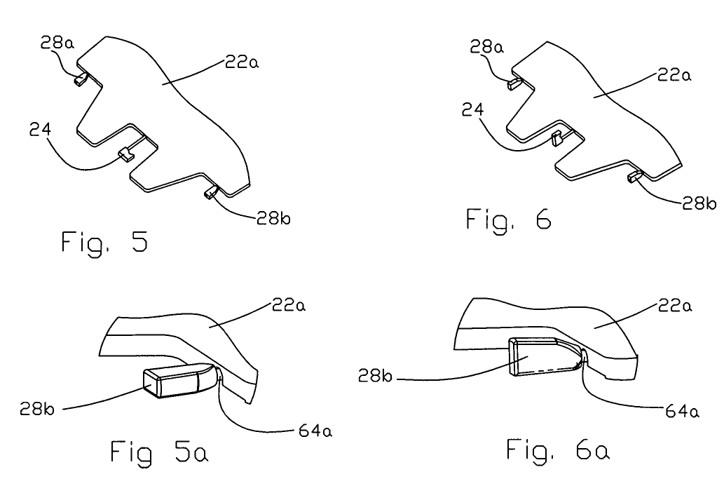

Having described in general the appearance of the gripper 20 with parts and elements that are exposed to the surface of the gripper body 22, let us consider now the aforementioned drive, force control, and actuating mechanisms enclosed in the gripper body 22. FIG. 2 is a schematic view of the end gripper 20 of the invention that shows the kinematics of the drive and actuation mechanisms in a wafer gripped position. In the illustrated embodiment, in order not obstruct the view, the object, e.g., a semiconductor wafer substrate W, is shown by a dash-and-dot line. A part of these mechanisms that are mounted on the upper side of the gripper body 22 is shown in FIG. 3, which is a three-dimensional view of the gripper 20 with the part of the housing portion 22b removed. In this drawing, the rotating gripping finger 24 is shown in an object-clamping position. FIG. 4 is a view similar to FIG. 2 but with the actuating mechanisms corresponding to gripping finger 24 in the wafer release position. These mechanisms will be further described with reference to FIGS. 2, 3, and 4.

The embodiment shown in FIGS. 2, 3, and 4 corresponds to one shown in FIG. 1 with one rotating gripping finger 24 and with two distal withdrawable wafer-supporting pads 28cand 28d.

The gripper body 22 supports a linear stepper motor 30 with a controller 32. The output shaft of the motor 30 is inserted into a sliding frame 34. The output shaft of the stepper motor 30 performs linear motions in the axial direction X-X towards or away from the semiconductor wafer W and will be hereinafter referred to as a plunger 36. The free end of the plunger 36 supports a pusher plate 38, which normally is urged away from the end face 34a of the sliding frame 34 by an expansion spring 40 located between the pusher plate 38 and the end face 34a of the frame 34 opposite to the semiconductor wafer W. The sliding frame 34 is slidingly installed in a guide 35 rigidly secure to the gripper body 22. Normally, the expansion spring is in a decompressed state shown in FIG. 4 and tends to return into this state and position when compressed. FIG. 4 is a schematic view similar to FIG. 2 but illustrating the mechanisms (plunger 36, pusher plate 38, etc.), pads 28a and 28b, and the gripping finger 24 in the wafer release position.

The actuating mechanism of the gripping finger 24 is comprised of a thin rotary shaft 42 that extends in the direction of axis X-X and is connected to the sliding frame 34 so that it can rotate relative to the sliding frame 34 on a thrust bearing 44 and at the same time can move together with the frame 34 in the direction of axis X-X. The rotating finger 24 is rigidly attached to the distal end of the rotary shaft 42.

The touch-force is precisely measured and controlled with the use of a special position sensor 46, which is attached to the sliding frame 34. The sensor 46 may comprise, e.g., a magnetic sensor (Hall sensor) that consists of a moveable magnetic flag 48 attached to the side of the aforementioned pusher plate 38 and a sensitive member, e.g. a Hall sensor chip 50 that responds to the position of the magnetic flag 48. The Hall sensor 46 produces an output voltage signal that is proportion to the position of the flag 48 relative to the Hall sensor chip 50. It is understood that an output signal of the Hall sensor 46 can be connected to the controller 32 of the stepper motor 30 and thus may control the final soft-touch gripping force. The final soft-touch gripping force corresponds to a predetermined value of an output signal of the Hall sensor 46. When this value reaches one set in the controller (not shown), the latter sends a stopping command to the controller 32 of the stepper-motor 30. Thus the final soft-touch gripping force of the gripping finger 24 relative to the edge E of the semiconductor wafer W can be adjusted by setting the controller to a required value.

A mechanism of rotation of the rotary shaft 42 and, hence, of he gripping finger 24 is comprised of a reversible electric motor 52 connected to the controller 32. The motor 52 drives a central gear wheel 56 through a drive gear 58 fixed to the output shaft of the electric motor 52 and an idler gear 60. The aforementioned rotary shaft 42 has a sliding fit in the central opening of the central gear 56 but cannot rotate relative to the central gear 56 as it connected thereto with the use of a sliding key or splines 62. Such an arrangement is necessary for rotating the gripping finger 24 into a hidden position, i.e., coplanar or below the external face and back surfaces of the insertable portion 22a when this portion of the gripper is inserted into the narrow space between the wafers of the wafer storage, and for axial movement of the gripping finger 24 between the wafer release position (not shown) and the wafer gripping position shown in FIG. 2, when the gripping finger 24 is pressed against the edge E (FIG. 2) of the semiconductor wafer W (FIG. 2).

As can be seen from FIG. 2, the aforementioned withdrawable wafer supporting pads 28a and 28b are attached to the distal ends of respective rotary shafts 64a and 64b. In the embodiment of the invention shown in FIG. 2, the pads 28a and 28b are withdrawn from the upward wafer supporting positions, in which they project above the upper surface of the insertable portion 22a, to hidden positions when they are located in flush or below the aforementioned surface, by rotation. Such a rotation between the aforementioned positions is carried out by rotating the rotary shafts 64a and 64b synchronously with the shaft 42 of the gripping finger 24. The rotary shafts are arranged parallel to the rotary shaft 42, i.e., to the longitudinal axis X-X of the gripper. One of these shafts, i.e., the rotary shaft 64a that supports the wafer supporting pad 28b, is an extension of the output shaft of the reversable motor 52 and thus rotates together with the gear wheel 58, while the second shaft 64b is inserted into the central opening of a gear wheel 66 and rigidly connected to the latter. The gear wheel 66 receives rotation from the aforementioned central gear 56 via an idler gear located between the central gear 56 and the gear wheel 66. In other words, the wafer supporting pads 28a and 28b can be turned between the positions where they do not project beyond the outlines of the insertable portion 22a of the gripper 20 and the positions where they project above the outlines of the insertable portion 22a for supporting the wafer W.

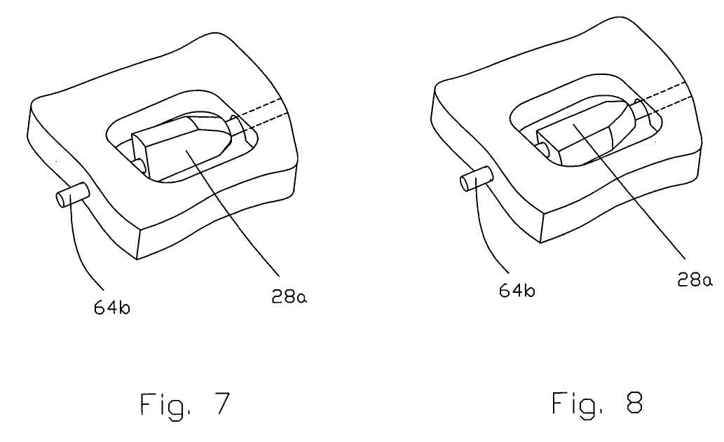

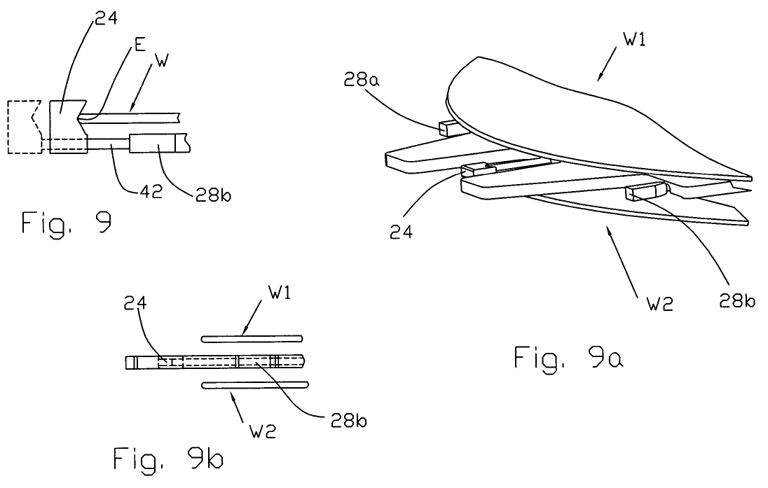

The gripping mechanism 20 of the embodiment shown in FIGS. 1, 2, and 3 operates as follows. The operation will be explained with reference to FIGS. 3 to 9, where FIGS. 5 and 6 show the gripping finger 24 in the wafer release or hidden position and in the projecting or wafer gripping position respectively; FIGS. 7 and 8 show one of the wafer-supporting pads, e.g., 28a, in the hidden position and in the projecting or wafer supporting position, respectively; and FIG. 9 is a fragmental side sectional view of the insertable portion 22a of the gripper in the wafer supporting position.

Prior to operation, e.g., insertion of the insertable portion 22a of the gripper into a space between the wafers in a wafer-storage cassette (not shown), the actuating mechanisms (i.e., the plunger 36, spring 40, pusher plate 38, etc.), pads 28a, 28b, and gripping finger 24 assume positions shown in FIGS. 4, 5, and 7. The gripping finger 24 is not only turned into the hidden position of FIG. 5, but also is shifted axially outwardly to the position of FIG. 4.

With mechanisms, gripping finger, and the pads in the above-described positions, the insertable portion 22a of the gripping mechanism 20 is inserted into the space between the wafers in the wafer storage cassette (not shown) by a manipulating device, e.g., by a robot arm (not shown), to which the gripping mechanism 20 is attached as an end effector. The gripping mechanism is inserted underneath the wafer that has to be removed from the cassette. The position of the gripping mechanism with the insertable portion 22a inserted between the adjacent wafers W1 and W2 is shown in FIG. 9a. The cassette that holds the wafers is not shown.

When the insertable portion 22a is aligned with the wafer located above the insertable portion, the rotating pads 28a and 28b are turned into position shown in FIG. 8, and the gripper 20 is slightly raised to bring the rotating pads 28a and 28b, as well as the stationary pads 28c and 28d, in contact with the peripheral parts of the wafer. This is shown in FIG. 9. The wafer is self-centered on the tapered surfaces of the pads. At the moment of the aforementioned contact the gripper finger 24 is located still in a slightly radially outward position relative to the wafer edge E. In FIG. 5, this outward position of the finger 24 is shown by broken lines. Since all the pads are accurately positioned on a common circumference, the wafer is self-centered. A provision of the pads eliminates surface contact between the wafer and the flat gripper, whereby a small gap is formed between the surface of the gripper body 22 and the surface of the wafer W. FIG. 9b shows gaps between the insertable portion of the gripper and the surfaces of the adjacent wafers in the cassette.

The stepper motor 30 is then activated and moves the plunger 36 with the pusher plate 38 linearly in the direction shown by arrow A in FIG. 2. The spring 40 is gradually compressed. When, in the course of the forward movement the gripping finger 24 comes into contact with the edge E of the wafer W with soft touch through the spring 40, the continuing movement of the plunger 36 in the direction of arrow A (FIG. 4) further compresses the spring 40 and grips the edge E of the wafer W between the finger 24 and the stationary sector 23 (FIG. 1). As the plunger continue to move in the direction of arrow A (FIG. 4), the resilient gripping forces is increased till a predetermined position of the pusher plate 38 shown in FIG. 2, where the 48 the Hall sensor chip 50 that responds to the position of the magnetic flag 48 on the pusher plate 38. The Hall sensor 46 produces an output voltage signal that is proportion to the position of the flag 48 relative to the Hall sensor chip 50. It is understood that an output signal of the Hall sensor 46 can be sent to the controller 32 of the stepper motor 30 and thus can be sued for controlling the final soft-touch gripping force. The final soft-touch gripping force corresponds to a predetermined value of an output signal of the Hall sensor 46. When this value reaches one set in the controller 32, the latter sends a stopping command to the stepper-motor 30. Thus the final soft-touch gripping force of the gripping finger 24 relative to the edge E of the semiconductor wafer W can be adjusted by setting the controller to a required value.

With the wafer W gripped in the gripper 20, the latter is withdrawn from the wafer cassette by the robot arm and is transported to a required position, e.g., for insertion into a wafer chuck (not shown) on a working station of the wafer processing equipment.

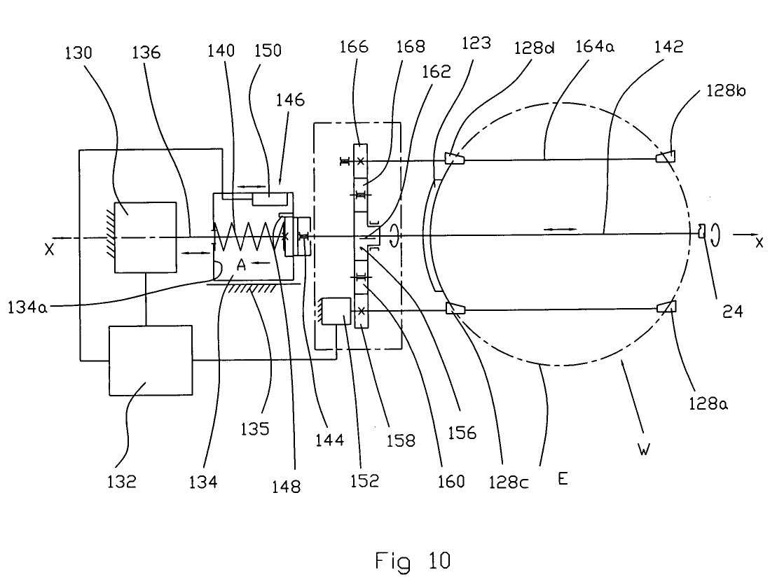

FIG. 10 shows another embodiment of the invention, where all four wafer supporting pads 128a, 128b, 128c, and 128d are rotatable and can be hidden below the outlines of the insertable portion of the gripper 120. The additional wafer-supporting pads 128c and 128d are attached to the same rotary shafts 164a and 164b as the pads 128b and 128c of the same type as in the previous embodiment. The rest of the construction of FIG. 10 is the same as one shown in FIG. 4, and therefore description thereof is omitted. Those parts of the gripper of FIG. 10 that are identical with the parts of FIG. 4 are designated by the same reference numerals but with an addition of 100. For example, the central gear 56 is designated by reference numeral 156, the motor 52 is designated by reference numeral 152, etc.

The method of the invention for loading/unloading and transferring flat objects into/from narrow spaces that consists of the steps of: providing an edge gripper for flat objects that comprises at least one gripping finger moveable between the position of gripping an object where the aforementioned at least one gripping finger projects beyond the outlines of the edge gripper surface and a hidden position where the aforementioned at least one gripping finger does not project beyond the outlines of the edge gripper surface, and at least a pair of object supporting pads that are moveable between the object supporting position where the aforementioned pads project beyond and above the outlines of the gripper surface and a hidden position where the aforementioned pads do not project beyond the outlines of the edge gripper surface; placing the aforementioned at least one gripping finger and the aforementioned at least a pair of the object supporting pads into said hidden position if the gripper is used for removing the object from said narrow space; inserting said gripper into said narrow space; aligning said at least one gripping finger and said at least a pair of said object supporting pads with said object; placing said at least a pair of said object supporting pads into said object supporting position; bringing said pads in contact with the edges of said flat object for self-centering of said flat object on said pads; bringing said at least one gripping finger into said position of gripping of said object; moving said at least one gripping finger towards the edge of said flat object for gripping said object in said object supporting position; and removing said gripper with said flat object from said narrow space.

The instable portion 22a of the gripper of the invention can be made as narrow as 1.6 mm. In this case, the free space that is left after subtracting the gripper body thickness 1.6 mm, 0.8 mm thickness of the wafer, and 2 mm tolerance on oscillations of the insertable portion from the pitch of 6.3 mm will be equal to 1.9 mm. This is sufficient for unobstructed insertion and removal of the gripper.

Thus, it has been shown that the invention provides a contamination-free edge gripping mechanism for removal/insertion of flat objects such as semiconductor wafer from/into narrow space. The mechanism has object supporting pads withdrawable in flush with the surface of the flat gripper for unobstructed insertion of the gripper into the aforementioned narrow space.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the principle of using withdrawable wafer-supporting pads is applicable to edge gripping mechanisms of other types, e.g., to those described in previous U.S. patent application Ser. No. 11/036,870 of the same applicants, where the distal finger is combined with two pivotal side gripping fingers. The projecting pads may be removed into a hidden position not necessarily by rotation. For example, the pads may be sunk into recesses on the surface of the gripping mechanism by tilting. The gripping finger can be turned by means other than gears, e.g., by a cranking mechanism. The gripper may pick up the wafers from the top position above the wafer. Although the gripping mechanism was described with reference to insertion into a wafer cassette, the wafer loaded into the gripper may be turned over by 180° by means of a robot arm and then loaded in this position into a wafer chuck. The principle of the invention is also applicable for insertion of the gripper through a narrow space in the processing chamber for access to the wafer chuck. Furthermore, the principle of the invention is applicable to the construction with a dual gripper mechanism that may contain two identical gripper fingers operating independently in cooperation with the respective withdrawable pads on the upper or lower planes of the insertable portion, while the aforementioned independent gripper fingers can be turned to positions required for gripping the wafer by arranging the gripper in an overhead or underneath position of the gripper with respect to the wafer.

1. A contamination-free edge gripping mechanism for loading/unloading and transferring flat objects through a narrow space, said contamination-free edge gripping mechanism comprising:
an elongated flat thin gripper body having a longitudinal axis, a hollow interior, an upper side, a backside, and a distal end;
flat object gripping means for gripping said flat objects in said contamination-free edge gripping mechanism;
at least two moveable object supporting and centering pads that are moveable between an object supporting and centering position where said at least two object supporting and centering pads project beyond and above said upper side and a hidden position where said at least two object supporting and centering pads do not project beyond said upper side;
additional object supporting means selected from the group consisting of moveable object supporting means and non-moveable object supporting means that support and centers said flat objects in combination with said at least two moveable object supporting pads; and
means for moving said at least two object supporting and centering pads between said object supporting and centering position and said hidden position.

2. The contamination-free edge gripping mechanism of claim 1, wherein said means for moving said at least two object supporting and centering pads comprises: two rotary shafts, wherein each of said two rotary shafts supports one of said at least two object supporting and centering pads, respectively; a reversible rotary drive motor having an output shaft, a gear wheel secured on said output shaft; a gear wheel secured on each of said two rotary shafts and receiving rotation from said gear wheel secured on said output shaft.

3. The contamination-free edge gripping mechanism of claim 2, further comprising intermediate gears between said gear wheel secured on said output shaft and each said gear wheel secured on each of said two rotary shafts.

4. The contamination-free edge gripping mechanism of claim 1, wherein said additional object supporting means comprise two additional moveable object supporting and centering pads located in a position that allows engagement of said additional moveable object supporting and centering pads with said flat objects on the side opposite to said at least two moveable object supporting and centering pads.

5. The contamination-free edge gripping mechanism of claim 4, wherein said additional object supporting means comprise two additional moveable object supporting and centering pads located in a position that allows engagement of said additional moveable object supporting and centering pads with said flat objects on the side opposite to said at least two moveable object supporting and centering pads, each one of said two additional moveable object supporting and centering pads being secured on each one of said two rotary shafts, respectively.

6. The contamination-free edge gripping mechanism of claim 3, wherein said additional object supporting means comprise two additional moveable object supporting and centering pads located in a position that allows engagement of said additional moveable object supporting and centering pads with said flat objects on the side opposite to said at least two moveable object supporting and centering pads.

7. The contamination-free edge gripping mechanism of claim 6, wherein said additional object supporting means comprise two additional moveable object supporting and centering pads located in a position that allows engagement of said additional moveable object supporting and centering pads with said flat objects on the side opposite to said at least two moveable object supporting and centering pads, each one of said two additional moveable object supporting and centering pads being secured on each one of said two rotary shafts, respectively.

8. The contamination-free edge gripping mechanism of claim 1, wherein said flat object gripping means comprise at least one gripping finger that can perform rotation around and can perform linear movement along an axis that is selected from the group consisting of said longitudinal axis and an axis parallel to said longitudinal axis.

9. The contamination-free edge gripping mechanism of claim 8, further comprising finger rotation drive means for performing said rotation around said axis from said reversible rotary drive motor simultaneously with movement of said at least two object supporting and centering pads.

9. The contamination-free edge gripping mechanism of claim 5, wherein said flat object gripping means comprise at least one gripping finger that can perform rotation around and can move along an axis that is selected from the group consisting of said longitudinal axis and an axis parallel to said longitudinal axis.

10. The contamination-free edge gripping mechanism of claim 8, further comprising finger rotation drive means for performing said rotation around said axis from said reversible rotary drive motor simultaneously with movement of said at least two object supporting and centering pads and said two additional moveable object supporting and centering pads.

12. The contamination-free edge gripping mechanism of claim 8, further comprising a linear drive motor having an output shaft and means for connecting said output shaft of said linear drive motor with said at least one gripping finger for performing said linear movement.

13. The contamination-free edge gripping mechanism of claim 12, wherein said means for connecting said output shaft of said linear drive motor with said at least one gripping finger comprises soft-touch gripping force control mechanism.

14. The contamination-free edge gripping mechanism of claim 11, further comprising a linear drive motor having an output shaft and means for connecting said output shaft of said linear drive motor with said at least one gripping finger for performing said linear movement.

15. The contamination-free edge gripping mechanism of claim 14, wherein said means for connecting said output shaft of said linear drive motor with said at least one gripping finger comprises soft-touch gripping force control mechanism.

16. The contamination-free edge gripping mechanism of claim 15, wherein said two rotary shafts, said reversible rotary drive motor, said linear drive motor, said intermediate gears, and said soft-touch gripping force control mechanism are completely closed and located in said hollow interior of said elongated flat thin gripper body.

17. A method of loading/unloading and transferring flat objects into/from narrow spaces comprising the steps of:
providing an edge gripper for flat objects that comprises at least one gripping finger moveable between a position of gripping said flat objects where said at least one gripping finger projects beyond the outlines of said edge gripper and a hidden position where said at least one gripping finger does not project beyond the outlines of said edge gripper, and at least a pair of object supporting pads that are moveable between an object supporting position where said at least a pair of said object supporting pads project beyond and above the outlines of said edge gripper and a hidden position where said pads do not project beyond the outlines of said edge gripper;
placing said at least one gripping finger and said at least a pair of object supporting pads into said hidden position if said edge gripper is used for removing one of said flat objects from said narrow space;
inserting said edge gripper into said narrow space;
aligning said at least one gripping finger and said at least a pair of object supporting pads with said one of said objects;
placing said at least a pair of said object supporting pads into said object supporting position;
bringing said pads in contact with the edges of said one of said flat objects for self-centering of said one of said flat objects on said pads;
bringing said at least one gripping finger into said position of gripping of said one of said objects;
moving said at least one gripping finger towards the edge of said one of said flat objects for gripping said one of said objects in said object supporting position; and
removing said edge gripper with said one of said flat objects from said narrow space.
